(19) United States
(12) Patent Application Publication
(10) Pub. No.: US 2010/0037197 A1
(43) Pub. Date: Feb. 11, 2010

(54) Method and apparatus for integrated circuit design

(75) Inventor: Takeshi Fukunaga, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/458,279

(22) Filed: Jul. 7, 2009

(30) Foreign Application Priority Data
Aug. 7, 2008 (JP) 2008-177878

(51) Int. Cl. G06F 17/50

(52) U.S. Cl. 716/12

(57) ABSTRACT

An integrated circuit design method includes: obtaining layout data of an integrated circuit; and updating the layout data to modify the layout of the integrated circuit. In updating the layout data, a first via placed on an interconnection is replaced with a plurality of second vias having a size smaller than that of the first via. The positions of the via origin points of the second vias on the interconnection is different from the position of the via origin point of the first via on the interconnection.

### INCORPORATION BY REFERENCE

This application claims the benefit of priority based on Japanese Patent Application No. 2008-177878, filed on Jul. 8, 2008, the disclosure of which is incorporated herein by reference.

### BACKGROUND OF THE INVENTION

1. Field of the Invention

The present invention relates to a method for layout design of a semiconductor integrated circuit, more specifically, to circuit layout modification for addressing design generation transition.

2. Description of the Related Art

In general, design rules under which layouts of semiconductor integrated circuit are designed become finer at a rate of about 0.7 times (about 0.5 times in the area ratio) per generation. A set of design rules determine process conditions in manufacturing semiconductor integrated circuits. In general, design rules specify minimum processing dimensions (such as interconnection width and spacing), but do not specify maximum processing dimensions. Therefore, a circuit block (such as a macro cell) designed for an earlier-generation process may be integrated into a semiconductor integrated circuit manufactured by a new-generation process. In some cases, a circuit block adapted to a new-generation process and another circuit block adapted to an earlier-generation process may be monolithically integrated within a single semiconductor integrated circuit. For example, a macro cell which cannot be made finer due to the circuit configuration or is not required to be finer because of the shortened TAT (Turn Around Time) may be integrated in an integrated circuit manufactured by a new-generation process with the layout adapted to the earlier-generation process unchanged.

In such case, vias and contacts are usually designed with sizes in accordance with design dimensions for the new-generation process due to difficulty of processing, while interconnection dimensions (such as the interconnection width) are unchanged from the earlier-generation process. When an earlier-generation circuit block is integrated within a new-generation circuit, sizes of vias and contacts are modified (or reduced) in accordance with the design rules of the new-generation process. Accordingly, in the layout design of the earlier-generation circuit block, widths and spacings of interconnections are designed in accordance with the design rules of the earlier-generation process, whereas sizes of vias and contacts are reduced in accordance with the design rules of the new-generation process.

Referring to FIG. 1, a description is given of a conventional method for modifying the via layout. In FIG. 1, a via 1 designed in accordance with an earlier-generation process is replaced with a via 200 of a size in accordance with a new generation process. In the conventional technique, the via 1 is reduced with the position of the via 1 (the via origin point) unchanged to be arranged as the new via 200. The via origin point means the position coordinates for defining the position of the via, which is defined as a certain point in the region where the via is arranged. For example, when a via-placed region is rectangular, the via origin point may be defined as the intersection point of diagonal lines of the rectangular via-placed region. When a via-placed region is circular, on the other hand, the via origin point may be defined as the center point of the circular via-placed region.

When vias and contacts are reduced in sizes, it is preferable to incorporate additional vias to increase the number of the vias for improving the reliability against the electromigration. When the via 1, which is to be modified in the layout, is subject to the electromigration significantly, the layout of the circuit is modified so as to incorporate one or more additional vias. In the example shown in FIG. 1, an additional via 201 is incorporated. When the via 201 is additionally incorporated, the position of the via is judged whether the position of the via 201 satisfies requirements of the minimum inter-via spacing and the minimum distance between the via and the interconnection edge (the via-metal coverage criterion), which are defined by design specifications (or design rules). In the conventional technique, the layout is modified so that the distance between the vias 201 and 200 and the distance between the via 201 and the edge of the interconnection 2 satisfy such requirements.

As thus described, additional vias are arranged in accordance with the design rules; however, a desired number of additional vias may be unable to be placed in some cases, depending on sizes and shapes of interconnections. When the interconnection 2 is excessively small in area as shown in the left section of FIG. 2, the size of the interconnection 2 is enlarged within a range meeting the design rules to arrange the via 201 as shown in the right section of FIG. 2.

In addition, Japanese Laid Open Patent Application No. JP-A 2007-317924 (hereinafter, the 924' application) discloses a layout method for placing an increased number of additional vias by relaxing the design rules for the layout of the additional vias.

The method shown in FIG. 2, however, may cause a problem that the area of the interconnection 2 cannot be enlarged due to a peripheral circuit (such as other interconnections) of the interconnection 2, on which the additional via 201 is to be arranged. The method shown in FIG. 2 may instead cause another problem that the area of the interconnection 2 cannot be increased to an extent satisfying the design rules. In this case, the fact that the additional via 201 is unable to be placed may result in the deterioration of the resistance against the electromigration, thereby decreasing the product yield of the entire circuit.

On the other hand, the technique disclosed in the 924' application, in which the design rules are relaxed for arranging additional vias, may undesirably decrease the product yield.

### SUMMARY

In an aspect of the present invention, an integrated circuit design method includes: obtaining layout data of an integrated circuit; and updating the layout data to modify the layout of the integrated circuit. In updating the layout data, a first via placed on an interconnection is replaced with a plurality of second vias having a size smaller than that of the first via. The positions of the via origin points of the second vias on the interconnection is different from the position of the via origin point of the first via on the interconnection.

In such method, in which the positions of the via origin points of the second vias are defined differently from that of the first via, the region in which the second vias are allowed to be placed is increased for a fixed interconnection size. This allows increasing the number of the second vias allowed to be placed without modifying the design rules.

The above-described method may be implemented on a computer in accordance with a program, which may be installed on the computer by using a recording medium.

The layout data updated through the above-described method may be used for producing masks (or reticles), and the masks may be used for manufacture of semiconductor integrated circuits.

The present invention allows incorporating additional vias with the via size thereof reduced, avoiding the design rules being violated.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a layout plan view showing an example of a method for reducing a via according to a conventional technique;

FIG. 2 is a layout plan view showing an example of the method for reducing the via according to the conventional technique;

FIG. 3 is a diagram showing an exemplary configuration of a design support system for integrated circuits in one embodiment of the present invention;

FIG. 4 is a functional block diagram of the design support system in one embodiment of the present invention;

FIGS. 5A to 5H are layout plan views showing an exemplary procedure of layout modification implemented by the design support system in one embodiment of the present invention; and

FIG. 6 is a plan view partially showing an exemplary layout of the semiconductor integrated circuit modified by the design support system in one embodiment of the present invention.

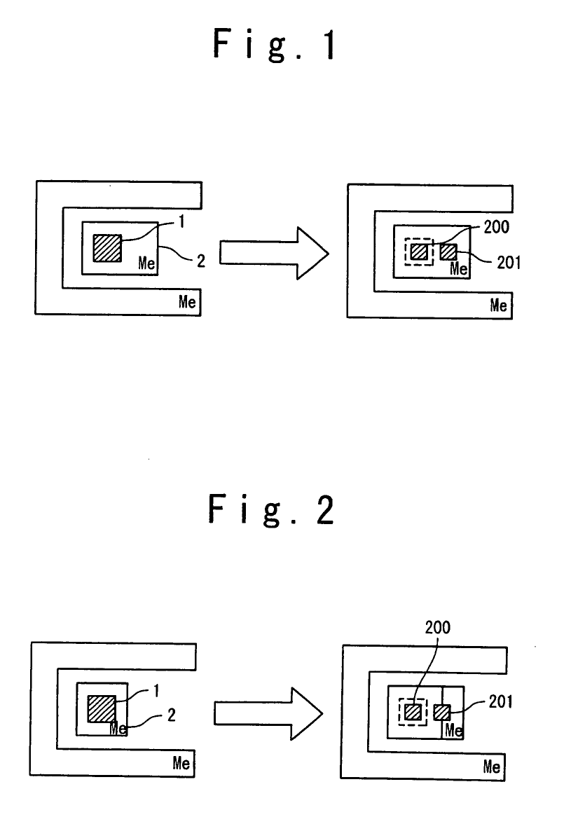

### DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

In the following, a description is given of a semiconductor integrated circuit design support system 100 (hereinafter, referred to as the design support system 100) which is used for layout design and modification of a semiconductor integrated circuit (or a semiconductor chip). The design support system 100 modifies the layout data of the semiconductor integrated circuit in the layout phase, so that a via placed in the circuit to be designed is replaced with a plurality of vias with the size thereof reduced.

### (Configuration of the Design Support System 100)

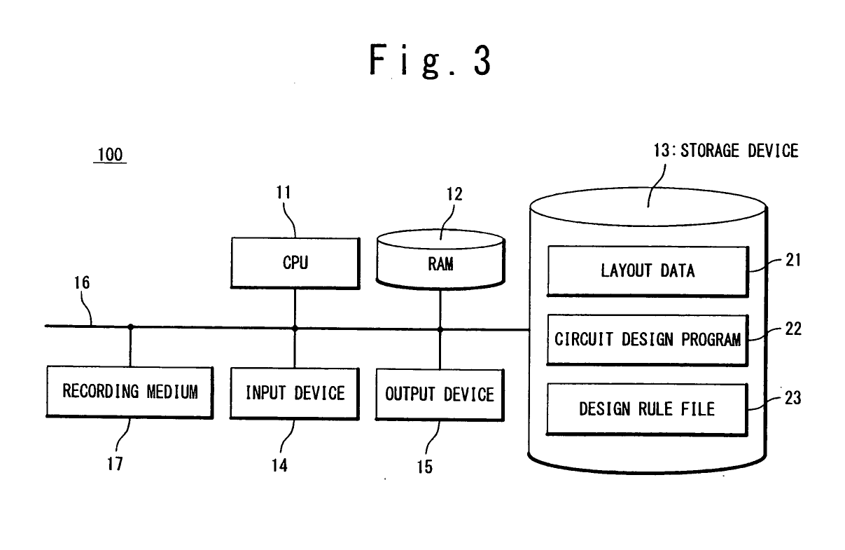

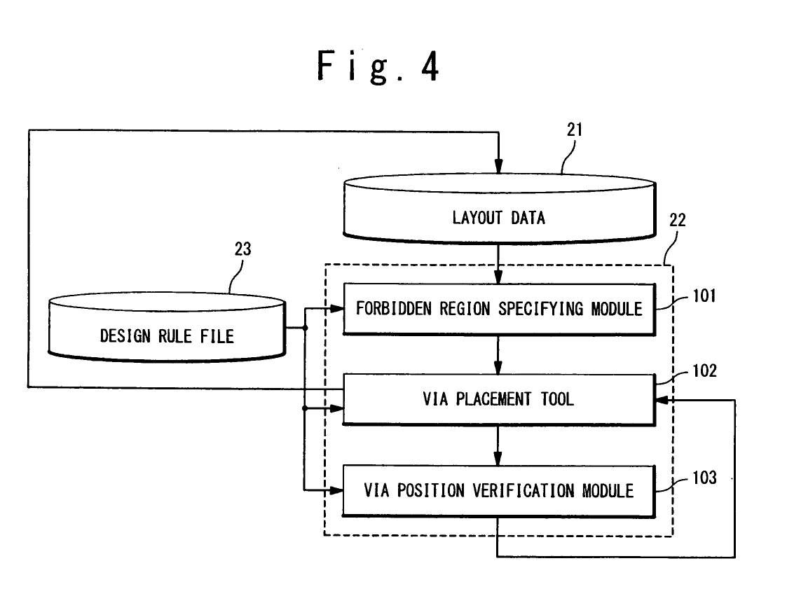

Referring to FIGS. 3 and 4, a description is given of an exemplary configuration of a design support system 100 in one embodiment of the present invention. FIG. 3 is a diagram showing the configuration of the design support system 100 in this embodiment. Referring to FIG. 3, the design support system 100 of this embodiment is equipped with a CPU 11, a RAM 12, a storage device 13, an input device 14, and an output device 15, which are mutually interconnected through a bus 16. The storage device 13 is an external storage device such as a hard disk and a memory. The input device 14 is operated by a user to provide various data to the CPU 11 and the storage device 13. The input device 14 may include a keyboard, a mouse, and a recording medium reader which reads data from a recording medium 17. The output device 15 visually outputs a layout result of the semiconductor integrated circuit generated by the CPU 11 or and various other information. The output device 15 may include a monitor or a printer.

The storage device 13 stores layout data 21, a design program 22, and a design rule file 23. The design program 22 may be installed on the storage device 13 by using the recording medium 17. In this case, the design program 22 is recorded on the recording medium 17.

The layout data 21 are indicative of the chip layout obtained by layout design. More specifically, the layout data 21 describe positions and configurations of respective circuit blocks (such as macro cells) arranged in the semiconductor integrated circuit, positions and widths of interconnections connecting between the circuit blocks, and the positions and sizes (diameters) of vias and contacts which provide electrical connections between diffusion layers and interconnection layers. The layout data 21 may be described in the GDS (Graphic Data System) format, the OASIS format or the like.

The design rule file 23 describes design rules which define processing dimensions of elements and interconnections in the layout of the semiconductor integrated circuit. The design rules described in the design rule file 23 are based on required product specifications and process rules to be utilized. The design rules in the design rule file 23 may include data specifying the minimum dimension of the via size, a via-to-via spacing criterion defining the minimum spacing between the vias, and a via-metal coverage criterion defining the minimum distance between a via and an edge of a metal interconnection on which the via is arranged. It is preferable that the design rule file 23 includes data describing processing dimensions defined for respective process generations used for the circuit to be designed.

The CPU 11 is responsive to operations implemented on the input device 14 for executing the design program 22 installed on the storage device 13. By executing the design program 22, the circuit layout is modified and a design rule check is performed on the semiconductor integrated circuit. In the execution of the design program 22, various data and programs read from the storage device 13 are temporarily stored in the RAM 12, and the CPU 11 executes various kinds of processes using the data in the RAM 12. Referring to FIG. 4, the design program 22 includes a forbidden region specifying module 101, a via placement tool 102, and a via position verification module 103.

FIG. 4 is a functional block diagram of the design support system 100 in this embodiment. First, a description is given of the overall operation of the design support system 100 with reference to FIG. 4. First, the forbidden region specifying module 101 specifies regions in which via placement is forbidden (hereinafter, referred to as the forbidden regions) on the basis of the layout data 21 and the design rule file 23. The via placement tool 102 performs placement of additional vias in a region other than the forbidden regions (the layout modification). Then, the via position verification module 103 verifies the positions of the newly placed vias using the design rule file 23 (a design rule check). The via placement tool 102 modifies the positions and/or number of the vias or confirms the positions of the newly arranged via based on the result of the design rule check to update the layout data 21.

Next, a detailed description is given of forbidden region specifying module 101, the via placement tool 102 and the via position verification module 103. The forbidden region specifying module 101 extracts a via necessary to be reduced in size referring to the layout data 21, and extracts the size and position coordinates of the extracted via. For example, a via within a macro cell of an earlier-generation process is extracted as the via to be reduced in size. As described later, the extracted via is replaced with a new via of a reduced size. The forbidden region specifying module 101 then specifies a region where the placement of the new via is forbidden on the basis of the position coordinates of the found via and the design rule file 23. Here, the forbidden region specifying module 101 refers to the design rule file 23 to specify the forbidden region based on the via-to-via spacing criterion defined for the new via provided after the replacement (e.g., the new-generation process). In addition, it is preferable to define a region including the via origin point of the extracted via to be replaced as the forbidden region so that the via origin point of the new via provided by the replacement is positioned at a position different from the via origin point of the extracted via to be replaced.

The via placement tool 102 specifies a region where a new via is allowed to be placed (hereinafter referred to as the placement-allowed region) in a region other than the forbidden region on the interconnection. For example, the via placement tool 102 specifies a region which satisfies the via-metal coverage criterion in a peripheral region of the forbidden region as the placement-allowed region. The via placement tool 102 specifies a region where the new via is to be arranged (hereinafter referred to as the via-placed region) in the placement-allowed region. In this case, the via placement tool 102 preferably refers to the design rule file 23 to specify the via-placed region on the basis of the via-to-via spacing criterion and the via size for the new arranging. The specified via-placed region is verified (or subjected to design rule check) by the via position verification module 103. When the placement-allowed region does not pass the design rule check, the via placement tool 102 specifies a different region in the placement-allowed region as a new via-placed region. Alternatively, the via-placed region determined as being failed may be simply removed. When the placement-allowed region passes the design rule check on the other hand, the via placement tool 102 places a new via in the via-placed region to update the layout data 21. In this case, the updated layout data 21 may be outputted to the output device 15. The specified placement-allowed region and via-placed region may also be outputted to the output device 15.

The via position verification module 103 refers to the design rule file 23 to perform the design rule check of the via-placed region (a via to be newly placed) based on the via-metal coverage criterion defined for the via to be newly placed. In this embodiment, the via position verification module 103 verifies whether the distance between the via-placed region (the via to be newly arranged) and the edge of the interconnection on which the via is placed exceeds the distance defined in the via-metal coverage criterion. The verification result is outputted to the via placement tool 102. The verification result may also be outputted to the output device 15.

### (System Operation)

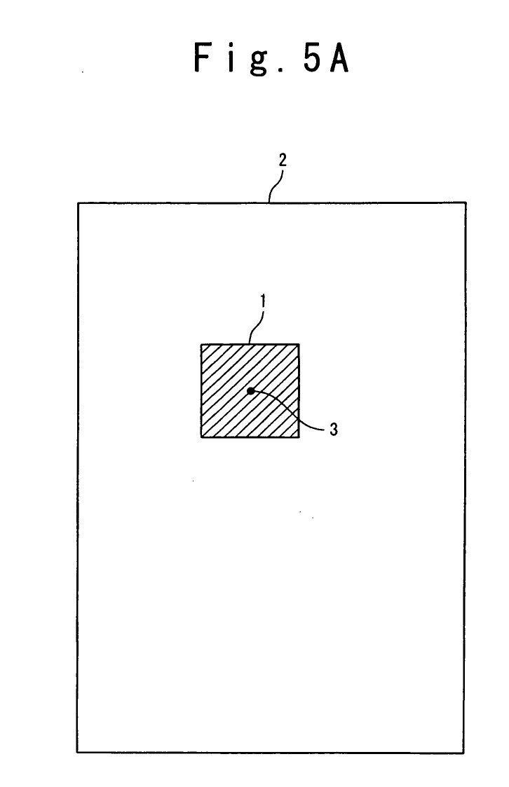

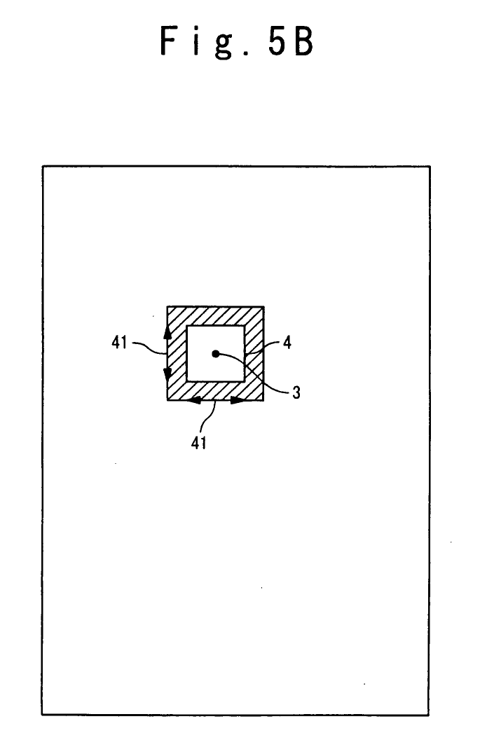

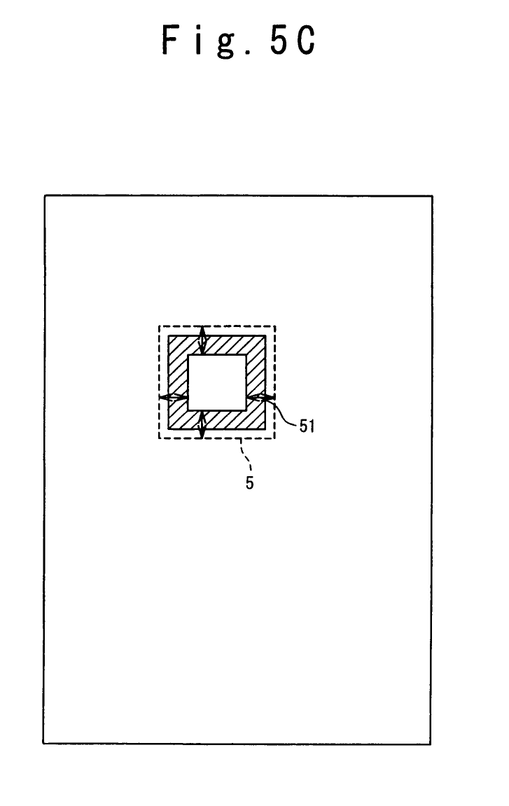

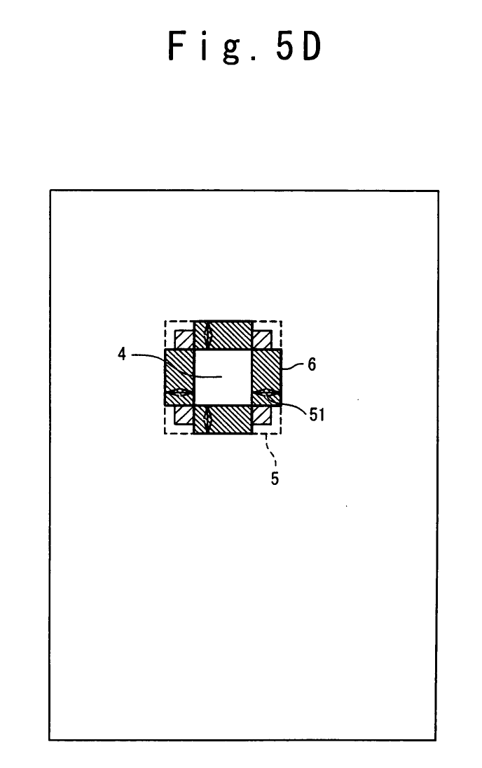

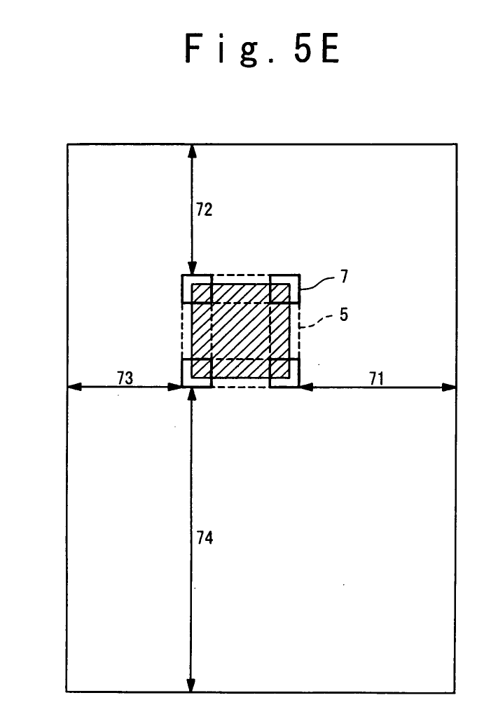

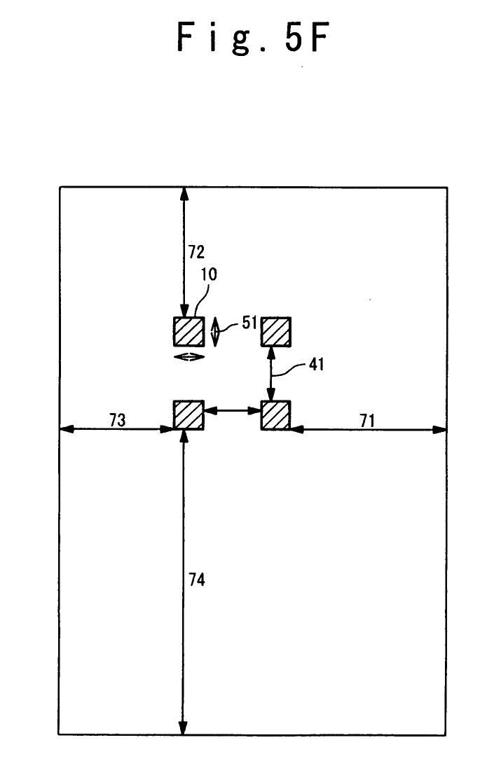

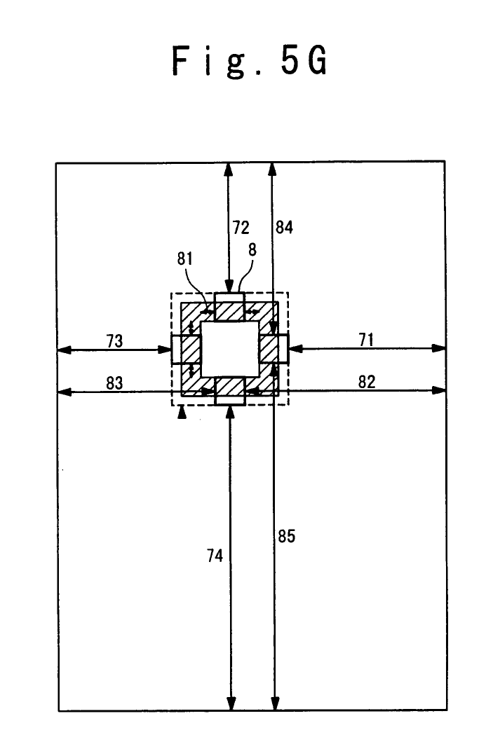

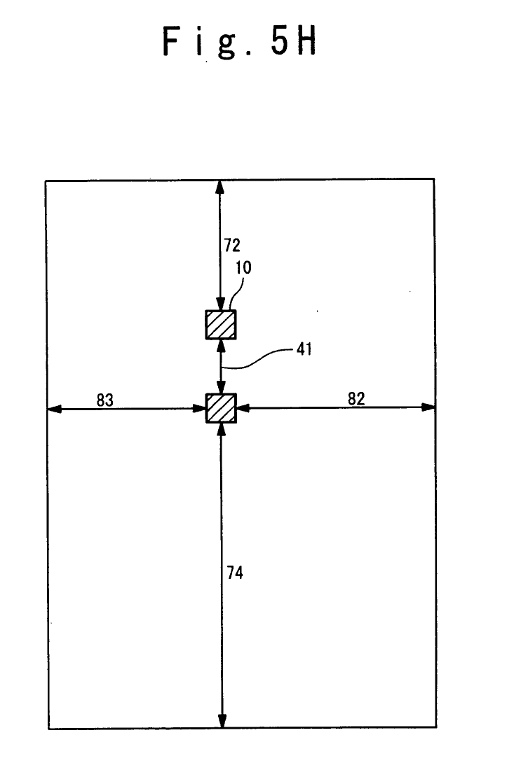

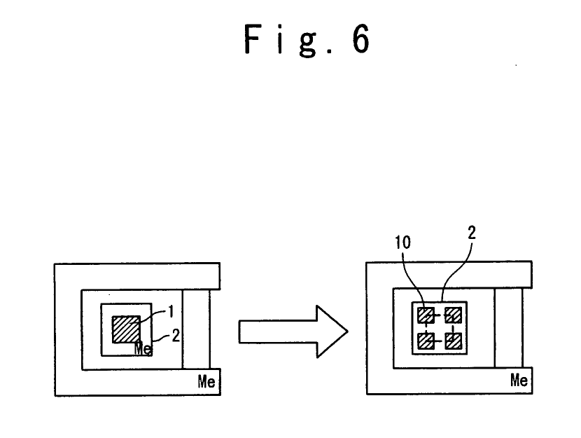

In the following, a detailed description is given of an exemplary layout modification implemented by the design support system 100 with reference to FIGS. 5A to 5H, in which the via 1 (a first via) formed on the metal interconnection 2 is replaced with a plurality of size-reduced vias 10 (second vias), as shown in FIG. 6.

FIG. 5A is a plan view partially showing an exemplary layout pattern of the circuit to be designed, after the chip layout process. The via 1 is initially placed on the interconnection 2. Referring to FIG. 5A, the forbidden region specifying module 101 extracts the size and position coordinates (here, the via origin point 3) when the via 1 is extracted as the via to be replaced. In this embodiment, the via 1 is defined as a square region, and the position coordinates of the barycenter point of the square region (the intersection point of the diagonal lines in the square) is extracted as the via origin point 3 while the length of one side thereof is extracted as the via size. In an alternative embodiment, the via 1 may be defined as a circular region. In this case, the center of the circular region is extracted as the via origin point 3, while the diameter is extracted as the via size.

Referring to FIG. 5B, the forbidden region specifying module 101 specifies a forbidden region 4 on the basis of the position of the via to be replaced (the via origin point 3) as a reference. More specifically, the forbidden region specifying module 101 defines the square having a barycentric point at the via origin point 3 so that the length of the sides of the square is equal to the minimum inter-via spacing 41 defined in the via-to-via spacing criterion for vias 10 newly provided by the via replacement (for example, in accordance with the new generation process) as the forbidden region 4. It is preferable that the forbidden region 4 and the newly-provided vias are similar in shape to one another, and the forbidden region 4 is specified so that the corresponding sides thereof are in parallel with each other.

Referring to FIG. 5C, the via placement tool 102 specifies a region where the vias 10 are allowed to be placed (a placement-allowed region 5) on the basis of the via size 51 of the vias 10, which are to be provided after the replacement; the via size 51 is equal to the length of the sides of the vias 10 when the vias are in a square shape. More specifically, the via placement tool 102 specifies a rectangle (square) around the forbidden region 4 so that the specified rectangle has a side longer by the via size 51 than the length of the sides of the forbidden region 4, and specifies the region between the rectangle and the forbidden region 4 as the placement-allowed region 5.

In the placement-allowed region 5, two regions opposed to each other across the forbidden region 4 are separated from each other by the minimum inter-via spacing 41. Therefore, when two vias are arranged in the two regions individually, the spacing between the two vias automatically complies with the design rule. In addition, regions in four corners of the placement-allowed region 5 (regions on the extensions of the diagonal lines of the forbidden region 4 in the placement-allowed region 5) are spaced from each other more than the minimum inter-via spacing 41. Therefore, when the vias 10 are arranged in the four regions individually, each via-to-via spacing automatically complies with the design rule.

In the following, a description is given of a method for specifying the regions at the four corners of the placement-allowed region 5 as the placement region of the vias 10 with reference to FIGS. 5D and 5E.

Referring to FIG. 5D, the via placement tool 102 specifies regions 6 by extending the respective sides of the forbidden region 4 by the via size 51. Referring to FIG. 5E, the via placement tool 102 specifies each of the four regions defined by removing the regions 6 from the placement-allowed region 5 as the placement regions 7. The placement regions 7 are square, each having sides of a length equal to the via size 51, and the distance from one placement region 7 to another is equal to the minimum inter-via spacing 41 defined in the via-to-via spacing criterion or more.

The via position verification module 103 verifies whether the placement regions 7 are specified in accordance with the design rules defined in the design rule file 23. Here, the distances 71 to 74 between the placement regions 7 and the edges of the interconnection 2 are checked whether the distances 71 to 74 comply with the design rules.

When no errors are found in the verification by the via position verification module 103, the via placement tool 102 updates the layout data 21 to place the new vias 10 in the placement regions 7 and to remove the via 1. As a result, multiple vias 10 (with the via size 51) are newly placed so that the distances 71 to 74 to the edges of the interconnection 2 and the respective via-to-via spacings comply with the design rules, as shown in FIGS. 5F and 6.

When any of the distances between the placement regions 7 and the edges of the interconnection 2 is determined to exceed the minimum via-to-interconnection-edge distance defined in the via-metal coverage criterion in the design rule check, on the other hand, the placement regions 7 are determined as being failed and removed. Instead, placement regions 8 are newly specified in different positions. In the following, a method for specifying the new placement regions 8 to arrange the vias 10 in the case where the placement regions 7 are determined as being failed with reference to FIGS. 5G and 5H.

The via placement tool 102 specifies specific regions within the regions 6 as the placement regions 8. For example, both of the long sides of the region 6 are equally reduced to specify square regions having the size of the via size 51 as the new placement regions 8. As shown in FIG. 5G, both of the long sides of the regions 6 are reduced by a length 81 to generate the placement regions 8.

The via position verification module 103 verifies whether the specified placement regions 8 comply with the design rules described in the design rule file 23. Here, the via position verification module 103 checks whether the distances 71 to 74 and 82 to 85 between the placement regions 8 and the edges of the interconnection 2 comply with the design rules. When the distance 73 does not comply with the design rules, for example, the placement region 8 corresponding to the distance 73 is removed. When the distances 72, 74, 82, and 83 comply with the design rules, as shown in FIG. 5H, on the other hand, the vias 10 are arranged in the placement regions 8 corresponding to the distances 72, 74, 82, and 83, and thus the remaining placement regions 8 whose spacing to the placement regions 8 violate the design rules are removed.

As described above, the design support system 100 of this embodiment places small new-generation vias at positions different from the position of the original via of an old-generation process when modifying the layout to reduce the size of the original via. This allows efficiently placing a plurality of new vias without changing the area of the interconnection 2. Thus, even if the layout of the interconnection 2 cannot be modified due to the complicated interconnection layout thereof, an increased number of vias can be arranged, avoiding lowering the resistance against electromigration due to the size reduction of the vias.

Further, the design support system 100 of this embodiment reduces and adds the vias so that the design rules are satisfied. This allows manufacturing the semiconductor integrated circuit with high reliability and improving the product yield.

Furthermore, the design support system 100 of this embodiment is suitable for modifying the layout of a via subject to the severe electromigration. For example, an isolated via with no other via placed around the via and a region in which the vias are arranged less densely are vulnerable to the electromigration. The design support system 100 of this embodiment performs the layout modification to reduce the via without deteriorating the EM resistance, since the number of the vias is increased with the size thereof reduced.

It is apparent that the present invention is not limited to the above embodiments, but may be modified and changed without departing from the scope of the invention. It should be noted that, although the above-described embodiments are described for the via placement, the same can be applied to contacts. In addition, the layout data 21 updated by the design support system 100 of this embodiment is used to prepare masks for manufacture of a semiconductor integrated circuit.

What is claimed is:

1. An integrated circuit design method comprising:
obtaining layout data of an integrated circuit; and
updating said layout data to modify said layout of said integrated circuit,
wherein said updating said layout data includes:
replacing a first via placed on an interconnection with a plurality of second vias having a size smaller than that of said first via,
wherein positions of said via origin points of said second vias on said interconnection is different from a position of a via origin point of said first via on said interconnection.

2. The integrated circuit design method according to claim 1, wherein said replacing includes:
specifying a forbidden region in which placement of a via are forbidden as a region of a predetermined size within which said first via origin point is positioned, and
placing said plurality of second vias in a region other than said forbidden region on said interconnection.

3. The integrated circuit design method according to claim 2, wherein said specifying said forbidden region includes:
specifying said forbidden region based on a via-to-via spacing criterion defined for said plurality of second vias.

4. The integrated circuit design method according to claim 1, wherein said replacing includes:
specifying a placement-allowed region in which said plurality of second vias are allowed to be placed, based on a via-to-via spacing criterion and a via size defined for said plurality of second vias; and
determining positions of said plurality of second vias in said placement-allowed region, based on a via-metal coverage criterion defining a minimum distance between a via and an edge of said interconnection.

5. The integrated circuit design method according to claim 4, wherein said replacing further includes:
modifying said positions of said plurality of second vias, when said positions of said plurality of second vias do not comply with said via-metal coverage criterion.

6. The integrated circuit design method according to claim 4, wherein said replacing further includes:
modifying a number of said plurality of second vias, when said positions of said plurality of second vias do not comply with said via-metal coverage criterion.

7. A recording medium which records a program that when executed controls a computer to perform a method comprising:
obtaining layout data of an integrated circuit; and
updating said layout data to modify said layout of said integrated circuit,
wherein said updating said layout data includes:
replacing a first via placed on an interconnection with a plurality of second vias having a size smaller than that of said first via,
wherein positions of said via origin points of said second vias on said interconnection is different from a position of a via origin point of said first via on said interconnection.

8. The recording medium according to claim 7, wherein said replacing includes:
specifying a forbidden region in which placement of a via are forbidden as a region of a predetermined size within which said first via origin point is positioned, and
placing said plurality of second vias in a region other than said forbidden region on said interconnection.

9. The recording medium according to claim 8, wherein said specifying said forbidden region includes:
specifying said forbidden region based on a via-to-via spacing criterion defined for said plurality of second vias.

10. The recording medium according to claim 7, wherein said replacing includes:
specifying a placement-allowed region in which said plurality of second vias are allowed to be placed, based on a via-to-via spacing criterion and a via size defined for said plurality of second vias; and
determining positions of said plurality of second vias in said placement-allowed region, based on a via-metal coverage criterion defining a minimum distance between a via and an edge of said interconnection.

11. The recording medium according to claim 10, wherein said replacing further includes:
modifying said positions of said plurality of second vias, when said positions of said plurality of second vias do not comply with said via-metal coverage criterion.

12. The recording medium according to claim 10, wherein said replacing further includes:
modifying a number of said plurality of second vias, when said positions of said plurality of second vias do not comply with said via-metal coverage criterion.

13. A method of manufacturing an integrated circuit comprising:
obtaining layout data of an integrated circuit;
updating said layout data to modify said layout of said integrated circuit;
preparing a mask by using said updated layout data; and
manufacturing said integrated circuit by using said mask,
wherein said updating said layout data includes:
replacing a first via placed on an interconnection with a plurality of second vias having a size smaller than that of said first via,
wherein positions of said via origin points of said second vias on said interconnection is different from a position of a via origin point of said first via on said interconnection.

14. The method according to claim 13, wherein said replacing includes:
specifying a forbidden region in which placement of a via are forbidden as a region of a predetermined size within which said first via origin point is positioned, and
placing said plurality of second vias in a region other than said forbidden region on said interconnection.

15. The method according to claim 14, wherein said specifying said forbidden region includes:
specifying said forbidden region based on a via-to-via spacing criterion defined for said plurality of second vias.

16. The method according to claim 13, wherein said replacing includes:
specifying a placement-allowed region in which said plurality of second vias are allowed to be placed, based on a via-to-via spacing criterion and a via size defined for said plurality of second vias; and
determining positions of said plurality of second vias in said placement-allowed region, based on a via-metal coverage criterion defining a minimum distance between a via and an edge of said interconnection.

17. The method according to claim 16, wherein said replacing further includes:
modifying said positions of said plurality of second vias, when said positions of said plurality of second vias do not comply with said via-metal coverage criterion.

18. The method according to claim 16, wherein said replacing further includes:
modifying a number of said plurality of second vias, when said positions of said plurality of second vias do not comply with said via-metal coverage criterion.
